(19) United States
(12) Patent Application Publication
(10) Pub. No.: US 2004/0240329 A1
(43) Pub. Date: Dec. 2, 2004

(54) Optical disk recording apparatus including an operating face panel capable of visual indication of recording status

(75) Inventors: Lu-Ming Chao, Chung-Ho City (TW); Gloria Chang, Chung-Ho City (TW)

Correspondence Address: LADAS & PARRY, 5670 WILSHIRE BOULEVARD, SUITE 2100, LOS ANGELES, CA, 90036-5679, US

(73) Assignee: MICRO-STAR INT'L CO., LTD.

(21) Appl. No.: 10/452,317

(22) Filed: May 30, 2003

(51) Int. Cl. G11B 7/085

(52) U.S. Cl. 369/30.26

(57) ABSTRACT

An optical disk recording apparatus writes data onto and reads data from a target optical disk, and is connected to a control device so as to control data recording and data reading operations of the optical disk recording apparatus. The control device generates recording status information of the target optical disk. The optical disk recording apparatus includes an optical disk drive coupled electrically to the control device and including an optoelectronic mechanism operable for writing data onto and reading data from the target optical disk, and an operating face panel mounted on the optical disk drive and including a display unit and a driver circuit coupled electrically to the optoelectronic mechanism and the display unit. The driver circuit activates the display unit so as to generate a visual indication of the recording status information from the control device.

### BACKGROUND OF THE INVENTION

1. Field of the Invention

The invention relates to an optical disk recording apparatus, more particularly to an optical disk recording apparatus including an operating face panel capable of visual indication of recording status.

2. Description of the Related Art

FIG. 1 illustrates a conventional optical disk drive for a computer (not shown) that includes a housing 40, a face panel 4 mounted on the housing 40, a carrier frame 41 disposed movably in the housing 40 and capable of extending through the face panel 4 for carrying a target optical disk (not shown), a set of control keys 42, such as a load/unload key, and fast forward and backward keys, provided on the face panel 4 and operable for controlling operation of the optical disk drive, and a volume adjuster 43 and an earphone jack 44 provided on the face panel 4. In addition, a set of indicating lights 46, 45 are provided on the face panel 4. The indicating light 46 indicates an activated state of the optical disk drive. The indicating light 45 indicates a data recording state of the optical disk drive when flashing.

However, the conventional optical disk drive cannot provide detailed recording status information, such as amount of data actually written onto the target optical disk, or amount of data already written onto the target optical disk during a data recording operation. At present, such information is known on a computer monitor to inform the user only when a computer installed with the optical disk drive executes relevant software, thereby resulting in inconvenience during use.

### SUMMARY OF THE INVENTION

Therefore, the object of the present invention is to provide an optical disk recording apparatus that includes an operating face panel capable of visual indication of recording status.

According to one aspect of the present invention, there is provided an optical disk recording apparatus adapted to write data onto and read data from a target optical disk. The optical disk recording apparatus is adapted to be connected to a control device so as to control data recording and data reading operations of the optical disk recording apparatus. The control device generates recording status information of the target optical disk. The optical disk recording apparatus comprises:

an optical disk drive adapted to be coupled electrically to the control device and including an optoelectronic mechanism operable for writing data onto and reading data from the target optical disk; and

an operating face panel mounted on the optical disk drive and including a display unit and a driver circuit coupled electrically to the optoelectronic mechanism and the display unit, the driver circuit activating the display unit so as to generate a visual indication of the recording status information from the control device.

According to another aspect of the present invention, there is provided an operating face panel for an optical disk drive. The optical disk drive includes an optoelectronic mechanism that is operable for writing data onto and reading data from a target optical disk, and is connected to a control device that controls data recording and data reading operations of the optoelectronic mechanism and that generates recording status information of the target optical disk. The operating face panel comprises:

a panel body adapted to be mounted on the optical disk drive and having an operating surface;

a display unit mounted on the operating surface of the panel body;

a driver circuit disposed in the panel body and coupled electrically to the display unit, the driver circuit being adapted to receive the recording status information through the optoelectronic mechanism and activating the display unit so as to generate a visual indication of the recording status information from the control device; and

a set of control keys provided on the operating surface of the panel body, connected to the driver circuit, and operable so as to generate control signals to be provided to the optical disk drive for controlling operation of the optoelectronic mechanism.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional optical disk drive;

FIG. 2 is a perspective view showing the first preferred embodiment of an operating face panel for an optical disk drive according to the present invention;

FIG. 3 is a schematic circuit block diagram illustrating the first preferred embodiment;

FIG. 4 is a schematic view showing a display unit of the first preferred embodiment in an activated state;

FIG. 5 is a schematic front view showing the second preferred embodiment of an operating face panel for an optical disk drive according to the present invention; and

FIG. 6 is a schematic view showing a display unit of the second preferred embodiment in an activated state.

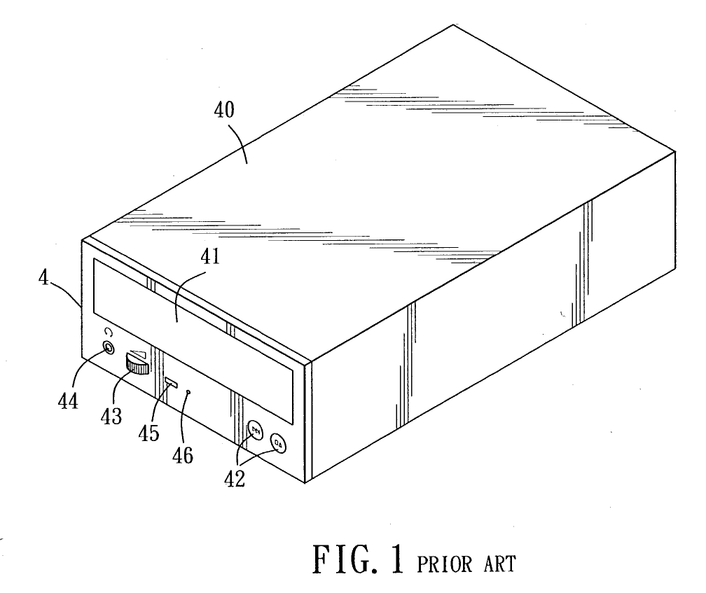

### DETAILED DESCRIPTION OF THE PREFERRED EMBODIMENTS

Before the present invention is described in greater detail, it should be noted that like elements are denoted by the same reference numerals throughout the disclosure.

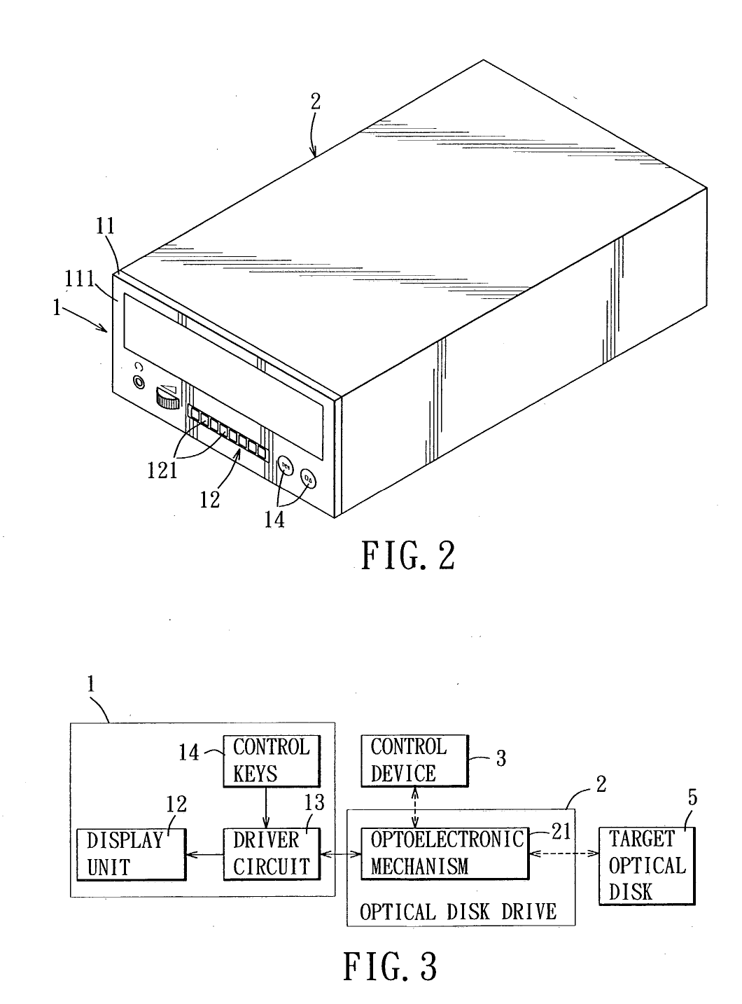

Referring to FIGS. 2 and 3, the first preferred embodiment of an operating face panel 1 for an optical disk drive 2 according to the present invention is shown. The optical disk drive 2 includes an optoelectronic mechanism 21 that is operable for writing data onto and reading data from a target optical disk 5, and is connected to a control device 3, such as a computer, that controls data recording and data reading operations of the optoelectronic mechanism 21 in a conventional manner and that generates recording status information of the target optical disk 5. In this embodiment, the optoelectronic mechanism 21 includes an optical head, a first driving unit for driving movement of the optical head, a second driving unit for driving rotation of a disk carrier, and a processing unit for signal processing and control of the optical head and the first and second driving units. Since the optoelectronic mechanism 21 is known in the art and is irrelevant to the claimed invention, a detailed description of the same is omitted herein. The operating face panel 1 includes a panel body 11, a display unit 12, a driver circuit 13, and a set of control keys 14.

The panel body 11 is adapted to be mounted on the optical disk drive 2 and has an operating surface 111.

The display unit 12 is mounted on the operating surface 111 of the panel body 11. In this embodiment, the display unit 12 includes eight light emitting elements 121, such as light emitting diodes, arranged in a row.

The driver circuit 13 is disposed in the panel body 11, and is coupled electrically to the display unit 12. The driver circuit 13 is adapted to receive the recording status information through the optoelectronic mechanism 21, and activates the display unit 12 so as to generate a visual indication of the recording status information from the control device 3. That is, the driver circuit 13 activates a number of the light emitting elements 121 in accordance with the recording status information from the control device 3. In this embodiment, the recording status information may be the amount of data actually written onto the target optical disk 5 or the amount of data already written onto the target optical disk 5 during a data recording operation of the optoelectronic mechanism 21.

The control keys 14 are provided on the operating surface 111 of the panel body 11, are connected to the driver circuit 13, and are operable so as to generate control signals to be provided to the optical disk drive 2 for controlling operation of the optoelectronic mechanism 21 in a known manner. In addition, an earphone jack and a volume adjuster are further provided on the operating surface 111 of the panel body 11.

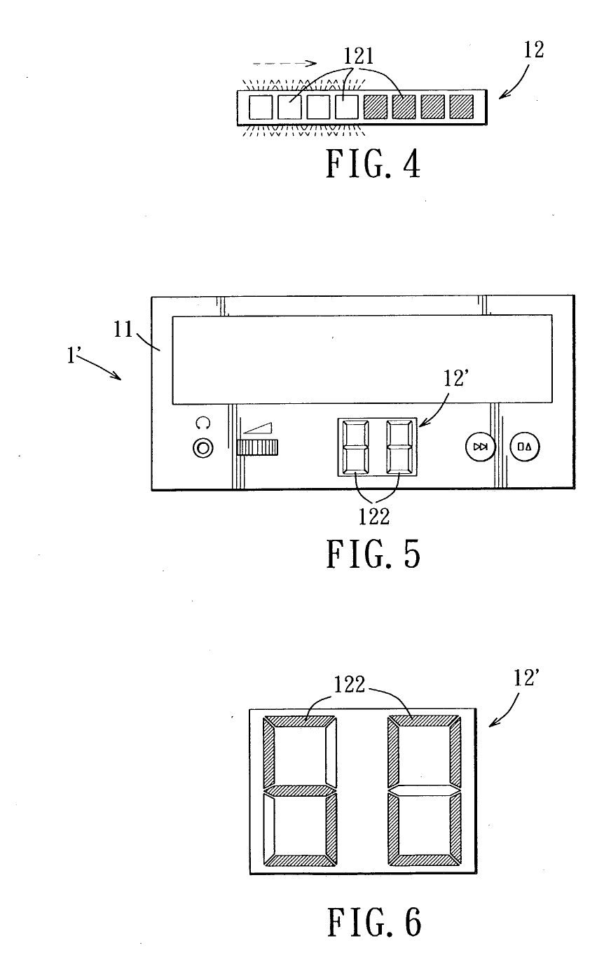

In an actual process, the optoelectronic mechanism 21 reads data files, which have a structure, such as table of content (TOC) or universal disk format (UDF), recorded on the target optical disk 5, after the target optical disk 5 is loaded into the optical disk drive 2, thereby obtaining the amount of data actually written onto the target optical disk 5 in units of time. Usually, an optical disk has a maximum data storage capacity in units of time substantially equal to 80 minutes. In this embodiment, each light emitting element 121 can represent a data storage capacity in units of time equal to about 10 minutes. Therefore, when the actual amount of data written onto the target optical disk 5 is greater than or equal to 40 minutes but less than 50 minutes, four light emitting elements 121, starting from a leftmost one of the light emitting elements 121, are activated, as shown in FIG. 4. On the other hand, when the light emitting elements 121 flash during the data recording operation, each light emitting element 121 can also represent a percentage value of 12.5% that is a ratio of the amount of data already written onto the target optical disk 5 during the data recording operation of the optoelectronic mechanism 21 to a total amount of data to be written onto the target optical disk 5. In other words, during the data recording operation, one half (50%) of the total amount of data has been written onto the target optical disk 5 when the four light emitting elements 121 are activated as shown in FIG. 4.

FIG. 5 illustrates the second preferred embodiment of an operating face panel 1′ for an optical disk drive according to this invention, which is a modification of the first preferred embodiment. Unlike the previous embodiment, the display unit 12′ includes two seven-segment displays 122. The driver circuit (not shown) activates the seven-segment displays 122 to generate a numerical indication of the recording status information from the control device (not shown). In this embodiment, as shown in FIG. 6, the seven-segment displays 122 can directly indicate the amount of data actually written onto the target optical disk 5 in units of time, such as 50 minutes. On the other hand, the seven-segment displays 122 can also directly indicate the percentage, such as 50%, of the total amount of data already written onto the target optical disk 5 during the data recording operation.

To sum up, due to the presence of the display unit 12, 12′, the operating face panel 1, 1′ of this invention can provide the detailed recording status information when compared to the aforesaid conventional optical disk drive, thereby resulting in convenience during use.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An optical disk recording apparatus adapted to write data onto and read data from a target optical disk, said optical disk recording apparatus being adapted to be connected to a control device so as to control data recording and data reading operations of said optical disk recording apparatus, the control device generating recording status information of the target optical disk, said optical disk recording apparatus comprising:
an optical disk drive adapted to be coupled electrically to the control device and including an optoelectronic mechanism operable for writing data onto and reading data from the target optical disk; and
an operating face panel mounted on said optical disk drive and including a display unit and a driver circuit coupled electrically to said optoelectronic mechanism and said display unit, said driver circuit activating said display unit so as to generate a visual indication of the recording status information from the control device.

2. The optical disk recording apparatus as claimed in claim 1, wherein the recording status information includes amount of data actually written onto the target optical disk.

3. The optical disk recording apparatus as claimed in claim 1, wherein the recording status information includes amount of data already written onto the target optical disk during the data recording operation of said optoelectronic mechanism.

4. The optical disk recording apparatus as claimed in claim 1, wherein said display unit includes a plurality of light emitting elements arranged in a row, said driver circuit activating a number of said light emitting elements in accordance with the recording status information from the control device.

5. The optical disk recording apparatus as claimed in claim 4, wherein said light emitting elements are light emitting diodes.

6. The optical disk recording apparatus as claimed in claim 1, wherein said display unit includes a set of seven-segment displays, said driver circuit activating said seven-segment displays to generate a numerical indication of the recording status information from the control device.

7. The optical disk recording apparatus as claimed in claim 1, wherein said operating face panel further includes
a panel body mounted on said optical disk drive and having an operating surface, said display unit being mounted on said operating surface, said driver circuit being disposed in said panel body; and
a set of control keys provided on said operating surface of said panel body, connected to said driver circuit, and operable so as to generate control signals to be provided to said optoelectronic mechanism for controlling operation of said optoelectronic mechanism of said optical disk drive.

8. An operating face panel for an optical disk drive, the optical disk drive including an optoelectronic mechanism that is operable for writing data onto and reading data from a target optical disk, and being connected to a control device that controls data recording and data reading operations of the optoelectronic mechanism and that generates recording status information of the target optical disk, said operating face panel comprising:
a panel body adapted to be mounted on the optical disk drive and having an operating surface;
a display unit mounted on said operating surface of said panel body;
a driver circuit disposed in said panel body and coupled electrically to said display unit, said driver circuit being adapted to receive the recording status information through the optoelectronic mechanism and activating said display unit so as to generate a visual indication of the recording status information from the control device; and
a set of control keys provided on said operating surface of said panel body, connected to said driver circuit, and operable so as to generate control signals to be provided to the optical disk drive for controlling operation of the optoelectronic mechanism.

9. The operating face panel as claimed in claim 8, wherein the recording status information includes amount of data actually written onto the target optical disk.

10. The operating face panel as claimed in claim 8, wherein the recording status information includes amount of data already written onto the target optical disk during the data recording operation of the optoelectronic mechanism.

11. The operating face panel as claimed in claim 8, wherein said display unit includes a plurality of light emitting elements arranged in a row, said driver circuit activating a number of said light emitting elements in accordance with the recording status information from the control device.

12. The operating face panel as claimed in claim 11, wherein said light emitting elements are light emitting diodes.

13. The operating face panel as claimed in claim 8, wherein said display unit includes a set of seven-segment displays, said driver circuit activating said seven-segment displays to generate a numerical indication of the recording status information from the control device.
